(19) United States
(12) Patent Application Publication
(10) Pub. No.: US 2009/0170055 A1
(43) Pub. Date: Jul. 2, 2009

(54) Emotional-condition control

(76) Inventor: Elwin R. Wilson, Portland, OR (US)

Correspondence Address: ROBERT D. VARITZ, P.C., 4915 SE 33RD PLACE, PORTLAND, OR, 97202, US

(21) Appl. No.: 12/006,553

(22) Filed: Jan. 2, 2008

(51) Int. Cl. G09B 19/00

(52) U.S. Cl. 434/236

(57) ABSTRACT

A self-implementable method for promoting a positive personal emotional condition in response to certain contra-stimuli including at least one of (a) the onset, and/or (b) the expected onset, of a defined-category event. The method includes the steps of (a) choosing a repeatable, normal-delivery-pace message pattern, (b) associating the chosen pattern with an internalized practice of implementing the mentioned promoting activity, (c) storing the chosen pattern in at least one, selected, personally proximate message-pattern storage medium, and (d) on the occurrence of such a contra-stimulus, deploying from the selected storage medium at least one personally engaging, normal-delivery-pace occurrence of the stored message pattern.

### BACKGROUND AND SUMMARY OF INVENTION

This invention relates to personal emotional-condition control. In particular, it relates to a self-implementable method, i.e., a method which requires no third-party coaching or assistance, for promoting the establishment of a positive personal emotional condition in response to certain contra-stimuli events. Non-exhaustive illustrations of such a positive emotional condition include conditions taking the forms of (1) happiness (in a range such as from contentment to extreme joy), (2) non-anger, and (3) positive care of one's self (i.e., care against various kinds of self-damaging or self-destructive behaviors). The term “contra-stimuli” is intended herein to refer to certain categories of events which have a tendency to produce emotional conditions that are effectively the opposites of a positive emotional condition such as those several, representative positive conditions just mentioned above.

There are many illustrations of circumstances, or events, wherein the methodology of this invention offers significant utility. Familiar, in this context, to most people, for example, are the phenomenon of (1) so-called “road rage”, and (2) the anger often aroused when someone steps, out of place, ahead of others, including one's self, in a line of people waiting for “front-of-the-line” attention. Other contra-stimuli event illustrations relevant to the practice of the invention include certain kinds of stimuli which may lead to “negative” (potentially physically harmful/damaging/destructive) behaviors, such as the urge to smoke, the urge not to stop smoking, the urge to over-eat, the urge to misuse a controlled substance, and so on.

In accordance with a preferred and best-mode manner of practicing the invention utilizing it's important, self-implementable characteristics, the invention methodology features, in general, promoting a positive personal emotional condition, as was stated above herein. In particular, it features such “promoting” activity employing the steps of: (a) choosing a readily repeatable, “normal-delivery-pace” message pattern, such as (1) a sound message pattern, (2) a visual message pattern, (3) a tactile message pattern, or (4) another suitable form of employable message pattern; (b) associating the chosen message pattern positively with an internalized practice of implementing the mentioned positive-emotional-condition promoting activity; (c) storing the chosen message pattern in at least one, selected, personally-proximate and suitable storage medium; and (d), on the occurrence of a defined contra-stimulus category, or the occurrences each of different, defined, contra-stimulus categories, deploying (for example, playing out, or otherwise presenting), from the selected storage medium, at least one personally engaging, “normal-delivery-pace” occurrence of the relevant stored message pattern so as to invoke the mentioned, associated, internalized, positive-emotional-condition promoting-activity practice.

The term “normal-delivery-pace”, as such is employed herein, is intended to refer to a message-pattern delivery pace, in any message mode, which is neither accelerated nor retarded, and which, further, is definitively essentially steady in nature in terms of delivery “rate”. Music and word message patterns furnish good illustrations of message-pattern conditions which are readily perceivable, ultimately, as being steady, or accelerated or retarded. In the practice of the present invention, I have found that it is important, for maximum methodology effectiveness, that delivered (deployed) message patterns engage the mind of the user at what the mind will internally and effectively recognize as being a normal and steady pace. Pace-deviated, non-normal-pace delivery of message patterns seems to affect the mind in ways which are less than ideal, and hence the present invention intentionally avoids these ways. Put another way, pace-normal message patterns, employed purposely by the present invention, engage the mind in a natural manner which has been found to lead to significant personal capability for positive emotional-condition control.

Accordingly, all references herein to message patterns, and to deployments, or deliveries, of message patterns, are to be understood as involving the just-described concept of “normal-delivery-pace” for such a pattern, whether or not specific “pace-related” language is directly presented in the associated text.

Continuing now with background and summary information regarding the invention, where the chosen message pattern is, for example, a sound pattern, such as a sound pattern which is word-based, a suitably stored sound copy of the pattern may be deployed under the control of the “user” by normal-pace “playing out” of the pattern in a manner which can be “heard” by the user. Several manners of storing a message pattern, and of deploying it as just mentioned, are described more fully hereinbelow.

What I have discovered regarding the practice of this invention is that the deploying or playing out of whatever is the chosen message pattern, sound or other, is immediately significantly effective, and progressively more so as it is repeated, when appropriate, over time, with respect to controlling one's emotional condition under the kind of contra-stimuli such as those mentioned briefly above. In fact, even over a relatively short period of methodology-use time, practice of the invention soon becomes substantially automatic in terms of promoting a mood of positivism in the face of a relevant contra-stimulus.

These and other features and advantages which are offered and featured by the present invention will become more fully apparent as the detailed description of the invention presented below is read in conjunction with the accompanying drawings.

### DESCRIPTION OF THE DRAWINGS

FIG. 1 is a high-level, block/schematic diagram illustration of the basic practice of the present invention.

FIGS. 2-4, inclusive, are also block/schematic diagrams, each respectively illustrating various, and differing, detailed manners of practicing the invention.

FIG. 5 pictures one form of an external electronic-sound-recording device, having both storing and playing-out modes of operation, which device may be employed in one manner of practicing the invention wherein the chosen message pattern takes the form of a normal-delivery-pace sound pattern.

### DETAILED DESCRIPTION OF THE INVENTION

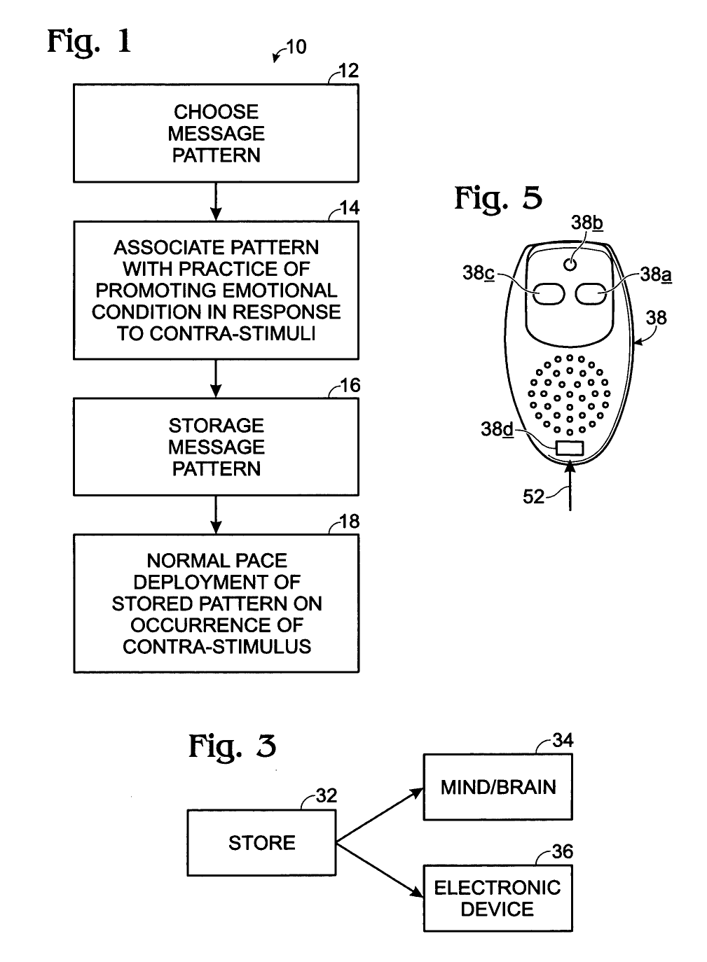

Turning now to the drawings, and referring first of all to FIG. 1, indicated generally at 10 is an overall, broad-level schematic block-diagram illustrating the fundamental steps employed in the practice of the present invention. More specifically, four, text-labeled, flow-interconnected blocks, 12, 14, 16, 18, furnish this view of the invention.

In particular, FIG. 10 illustrates a self-implementable method for promoting a positive personal emotional condition, such as a positive condition of the illustrative types mentioned above, namely, (1) happiness (including the range mentioned earlier herein), (2) non-anger, and (3), positive care of one's self (as illustrated by the several stated examples), in response to certain, defined-category contra-stimuli, or events. These contra-stimuli are recognized herein as including, in general, in terms of “presentation” or “manifestation”, at least one of (a) the onset, and/or (b) the expected onset, of a particular, defined-category contra-stimulus event, such as those several which were mentioned as illustrations above herein.

As pictured in FIG. 10, the steps of this emotional-condition promoting methodology include (a) choosing a repeatable, personally discernible, normal-delivery-pace message pattern, block 12, (b) associating the chosen message pattern, block 14, with a personally internalized practice of implementing the intended emotional-condition promoting activity on recognizing (such as later hearing) the chosen message pattern, (c) storing the chosen message pattern in at least one, selected, personally proximate (preferably immediately nearby) message-pattern storage medium, block 16, and (d) on the occurrence of the, or a, selected contra-stimulus, deploying (such as playing out) from the selected storage medium at least one personally engaging (such as hearable), normal-delivery-pace occurrence of the stored message pattern, block 18.

Appropriate, positive-directed, emotional-condition “behavior” then effectively comes into place and play, and over time, especially with repeated practice of the methodology of the invention, takes root rapidly, assuredly, and progressively more “automatically” with recurrent occurrences.

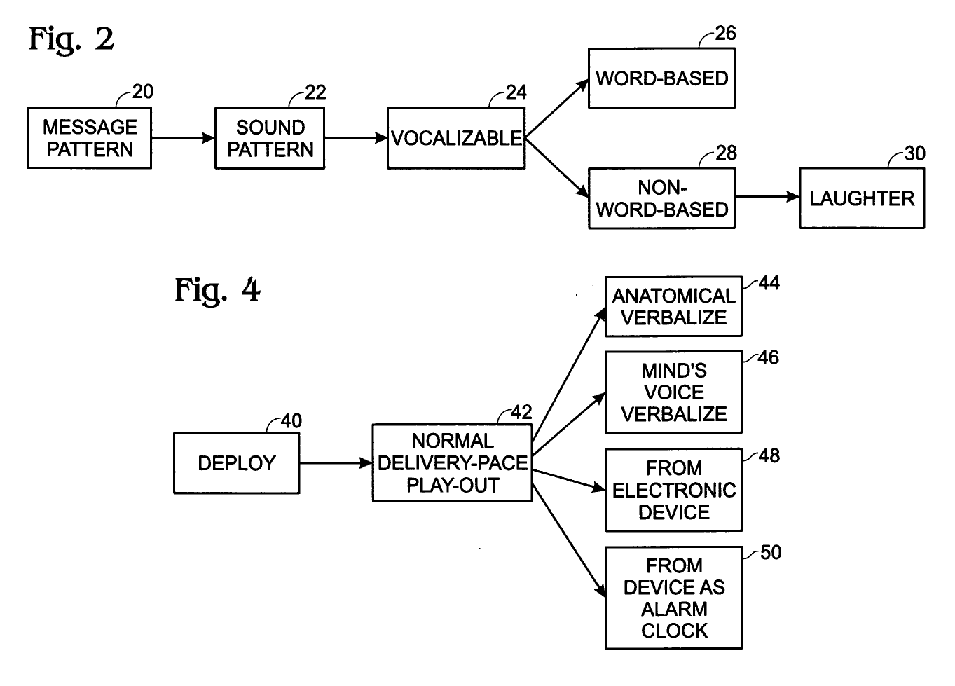

FIG. 2 illustrates, in a somewhat more detailed block/schematic fashion, that the chosen message pattern, block 20, may be a sound pattern, block 22. This sound-based pattern may be vocalizable, block 24, and might be a word-based pattern, block 26, like the phrases “Where am I going with this?”, and “It is what it is!”, or a non-word based pattern, block 28, like a small burst of laughter, block 30. Where a chosen sound message pattern is, alternatively, a non-vocalizable pattern, it might, for example, be an instrumental melody.

While not necessarily, as stated earlier herein, the only message-pattern types to be employed, sound-based patterns have been found to be particularly useful and effective in the practice of the invention.

Notwithstanding this sound-pattern-utility preference, a chosen message pattern, employable successfully in the practice of the present invention, may certainly be something other than a sound pattern. For example, it could be some form of visual pattern, such as a visually displayable verbal expression, or even a non-verbal image of some personally selected form. It could also be some form of a tactile message “pattern”, such as a selected form of easily carried touchstone.

FIG. 3 illustrates that a stored message pattern, block 32, such as a word-based, or laughter-based, sound message pattern, may preferably be stored, for examples, internally in the user's mind/brain, block 34, for easy recall when wanted, or in an appropriate, personally-portable electronic recording device, represented generally by block 36, for easy playing out when desired.

More will be said shortly about different ways of storing, and later deploying, or playing out, a chosen message pattern, such as a sound pattern. However, at this juncture, it may be useful to discuss briefly certain terminology which is employed herein involving the useful “mind/brain” internalizing concept, and the associated concepts of outward “anatomical” verbalizing and hearing.

With respect to the “mind/brain” references used herein, these relate to the familiar concepts of “the mind's eye”, “the mind's ear”, and “the mind's voice”—concepts which are readily understood by most people, in terms of how people can record and call up at will, and internally experience, both in internal vision and sound, images and sounds with which they are familiar, and indeed have internally “recorded”, such as the images of people, words, and other sounds, such as the sounds of familiar voices, melodic tunes, and different styles of laughter. Mind/brain playing out of an internally stored message pattern may thus be for experiencing by the mind's eye, by the mind's ear, or both, if desired.

“Anatomical” verbalizing and hearing relate to a user's behaviors of sounding out, with the outward anatomical voice, an internally recorded (memorized) sound message pattern of any vocalizable type, thus for this pattern to be heard outwardly by the anatomical ear.

Message-pattern storage and recall (playing out) as referred to herein, accordingly, fully include both internal mind/brain storage, and playing out as expressed just above, and external playing out, as by anatomical verbalizing and hearing.

Other forms of message-pattern storage and playing out are also employable, as will shortly be more fully described.

In terms, generally, of message storage, the kind of storage specifically contemplated herein is referred to as personally proximate storage. What this means is that whatever medium is chosen for the purpose of storing a selected message pattern, this storage medium is (and preferably should be) immediately available to the user—i.e., in the close proximity of and to that user. Clearly such is the case if the mind/brain is employed as a storage medium. Where storage, as for example of a sound message pattern, takes the form of electronic storage, such as is suggested by block 36 in FIG. 3, this may be implemented in and by a small, personally carriable, highly portable electronic recording device, such as the very simple electronic sound-recording device shown at 38 in FIG. 5. More will be said shortly about device 38.

Turning attention at this point to FIG. 4, here what is illustrated is that deployment, block 40, of a suitably recorded message pattern, for example where that pattern is a recorded sound pattern, may be accomplished by normal-delivery-pace playing out, block 42, of the recorded message, in any one or more of several different ways which are also illustrated in FIG. 4. More specifically, and describing playing-out activity in terms of a sound pattern, such playing out may take the form of (a) anatomical verbalizing, i.e., speaking, block 44, of the message which has been memorized by the user, (b) internally verbalizing an internally recorded sound message using the mind's voice, block 46, (c) operating the play-out mode, block 48, in an electronic recording device, such as in recording device 38 as pictured in FIG. 5, and (d) playing out an electronically recorded message in what is referred to herein as an “alarm-clock” mode, block 50, made available in a suitably constructed, alarm-clock-mode-capable device, such as device 38 shown in FIG. 5. Internal playing out of a personally mentally recorded sound pattern may be performed collaboratively by what has above been referred to herein as the mind's voice and the mind's ear.

Playing out of a message pattern of a non-sound type may involve many other approaches, such as the internal playing out to the mind's eye of an internally recorded visual message pattern, the playing out of a recorded electronically stored image, the “playing-out” by the looking at a carried, print-recorded, visual message-pattern image, the “playing out” by the touching of a selected, tactile message pattern object, and so on. In relation to a chosen tactile-form message pattern, the concept of recording or storing such a “pattern” involves basically the choosing of a particular, preferably personally carriable, tactile object, and definitively associating a selected mood of relevant positivism to the feel of this object, whereby the “feel” of the object becomes synonymous with the desired message of emotional positivism.

Focusing final drawing attention, now again, on FIG. 5, where an electronic recording device 38 is pictured, this device, in its most basic form, is characterized with both a sound-recording mode, as implemented through an action button 38a and a microphone 38b, and a playing-out mode, as activated by a button 38c.

An alternative form of an electronic device 38 may include an internal alarm-clock capability, such being suggested and illustrated generally by small, shaded block pictured at 38d in FIG. 5. Activating of the device in an alarm-clock mode is accomplished by an appropriate control which is represented by an arrow 52 in FIG. 5. The alarm-clock mode capability of such a device is one which, of course, includes appropriate controls therein (not specifically shown in the drawings) for establishing a time of day when the relevant device will operate as the deliverer of an “alarm”. A delivered alarm, in accordance with one manner of practicing this invention, takes the form of the playing out of a recorded sound message pattern. In such a mode of operation, a user might program such an alarm-capable device to play out, for example, each morning at a designated time, or even at plural times during a day, a selected, prerecorded sound message pattern—a pattern which may serve in a precursor fashion to remind the user to take control of his or her emotional state whenever, should such later occur, a selected/defined contra-stimulus either actually occurs, or appears to be about to occur. In other words, in the alarm-clock mode of implementation and practice of the present invention, an early playing out of a prerecorded chosen message pattern can function, for example, as a preliminary, “prepare-for-the-coming-day”, stage-setting emotional-preparation activity, arming a person in advance to be ready to take positive control over an emotional state in anticipation of the possible occurrence of a selected contra-stimulus.

Thus, the present invention proposes a special and unique methodology for promoting a positive personal emotional condition, such as the illustrative conditions of (1) happiness, (2) non-anger, and (3) positive care of one's self, in response to various kinds of what have been described herein with the terminology “contra-stimuli”. Especially important is that the methodology of the invention is completely self-constructible and self-implementable without the need for engaging the services and attendant costs of third-party professional therapy and the like.

With respect to selected and various kind of contra-stimuli which effect a particular person, knowingly, that person may easily choose an appropriate normal-delivery-pace message pattern in any one of several formats suggested herein, or may select a plurality of such message formats to suit different kinds of contra-stimuli, which message patterns are then recorded and played out under control of the user at desired points in time. Thus a message pattern, which preferably takes the form of any one of several different types of sound patterns, including, perhaps even more preferably, a vocalizable, normal-pace sound pattern, such as a word passage, and/or a quality of normal-pace laughter, may also include message patterns taking the forms of visual imagery, including the visual image of a word passage, and as a further illustration, even tactile imagery.

A selected message pattern may be recorded in any suitable fashion, as for example, completely internally in the mind's memory, or in some external recording device, such as an external sound recording device, or even an external visual-image recording device, with recording preferably taking place in a manner which is “personally proximate” the user in the sense that the recording instrument mentality is closely and immediately available to a user.

Where a vocalizable word-based message pattern is chosen, as such is effectively recorded in the mind's memory, is a relatively simple matter for a person to “play out” this message by speaking it anatomically to be heard by the anatomical ears, or by speaking it “internally” utilizing the mind's voice so as to have message heard by the mind's ear.

Practical experience employed by the testing of this methodology personally has revealed it to be extremely effective in implementing control over an emotional condition which could easily stabilize unhappily the negative mode of being and behavior, and the methodology has shown a capability, over relatively short periods of time, of producing somewhat automatic control responses in relation to the actual onsets, or the anticipated onsets, of various contra stimuli.

Accordingly, while a preferred and best mode embodiment of, and manner of practicing the present invention have been illustrated and described herein, and certain variations and modifications suggested, it will be understood that other variations and modifications are possible and may be made useable in the implementation of the invention without departing from the central spirit of the invention.

I claim:

1. A self-implementable method for promoting a positive, personal emotional in response to certain contra-stimuli including at least one of (a) the onset, and/or (b) the expected onset, of a defined-category event, said method comprising
choosing a repeatable, normal-delivery-pace message pattern,
associating the chosen pattern with an internalized practice of implementing the mentioned promoting,
storing the chosen pattern in at least one, selected, personally proximate message-pattern storage medium, and
on the occurrence of such a contra-stimulus, deploying from the selected storage medium at least one personally engaging, normal-delivery-pace occurrence of the stored message pattern.

2. The method of claim 1, wherein the message pattern takes the form of a word-based expression.

3. The method of claim 1, wherein the chosen message pattern takes the form of a chosen sound pattern.

4. The method of claim 3 with respect to which the chosen sound pattern is a vocalizable pattern.

5. The method of claim 4, wherein the vocalizable pattern takes the form of a word-based expression.

6. The method of claim 4, wherein the vocalizable pattern takes the form of a non-word-based expression.

7. The method of claim 6, wherein the mentioned non-word-based expression takes the form of laughter.

8. The method of claim 3, wherein said storing is performed utilizing the mind/brain as the proximate storage medium.

9. The method of claim 8, wherein said deploying takes the form of playing out, and said playing out is performed by anatomical verbalizing of the stored sound pattern so as to enable that pattern to be heard by the anatomical ear.

10. The method of claim 8, wherein said deploying takes the form of playing out, and said playing out is performed by mind's-voice verbalizing of the stored sound pattern so as to enable that pattern to be heard by the mind's ear.

11. The method of claim 3, wherein said storing is performed utilizing an external, electronic sound-recording device having both storing and playing-out modes of operation, said deploying takes the form of playing out, and said playing out is performed by operating the device in its playing-out operating mode.

12. The method of claim 11, wherein the mentioned sound-recording device additionally possesses an alarm-clock playing-out mode of operation, and said playing out is performed by implementing the device's alarm-clock operating mode.
